(19) United States
(12) Patent Application Publication
(10) Pub. No.: US 2017/0026861 A1
(43) Pub. Date: Jan. 26, 2017

(54) Measurement Enhancements for LTE Systems

(71) Applicant: MEDIATEK INC., Hsinchu (TW)

(72) Inventors: Li-Chuan Tseng, Taipei City (TW); Chia-Chun Hsu, New Taipei City (TW); Per Johan Mikael Johansson, Kungsangen (SE)

(21) Appl. No.: 15/214,295

(22) Filed: Jul. 19, 2016

Related U.S. Application Data
(60) Provisional application No. 62/194,363, filed on Jul. 20, 2015.

(51) Int. Cl. H04W 24/08; H04B 17/318; H04W 76/04

(52) U.S. Cl. CPC H04W 24/08; H04W 76/048; H04B 17/318

(57) ABSTRACT

A method of mobility management with smart measurement is proposed. The present invention addresses modifications on RRM measurements as well as mobility control procedures in order to improve mobility performance for UE configured with longer connected mode DRX cycle. Since the poor mobility performance when applying extended DRX cycle mainly results from reduced number of measurements, one solution is to dynamically adjust the measurement interval so as to trigger the measurement reporting in time.

### CROSS REFERENCE TO RELATED APPLICATION

This application claims priority under 35 U.S.C. §119 from U.S. Provisional Application No. 62/194,363, entitled “Measurement Enhancements for LTE Systems,” filed on Jul. 20, 2015, the subject matter of which is incorporated herein by reference.

### TECHNICAL FIELD

The disclosed embodiments relate generally to wireless communication systems, and, more particularly, to user equipment (UE) measurements and mobility control procedure for LTE systems.

### BACKGROUND

Long-Term Evolution (LTE) systems offer high peak data rates, low latency, improved system capacity, and low operating cost resulting from simple network architecture. An LTE system also provides seamless integration to older wireless network, such as GSM, CDMA and Universal Mobile Telecommunication System (UMTS). Enhancements to LTE systems are considered so that they can meet or exceed IMA-Advanced fourth generation (4G) standard. One of the key enhancements is to support bandwidth up to 100 MHz and be backwards compatible with the existing wireless network system. In LTE/LTE-A systems, an evolved universal terrestrial radio access network (E-UTRAN) includes a plurality of evolved Node-Bs (eNBs) communicating with a plurality of mobile stations, referred as user equipments (UEs).

Typically, each UE needs to periodically measure the received signal quality of the serving cell and neighbor cells and reports the measurement result to its serving eNB for potential handover or cell reselection. The measurements may drain the UE battery power. In order to keep UE battery consumption low, the UE needs to toggle between sleeping and awake states. Preferably it should be possible for UEs in connected mode to apply similar sleep/awake performance as in Idle mode, to have similar battery consumption as in Idle mode. To save power, Discontinuous Reception (DRX) needs to be used in Connected mode, with short awake times and long sleep cycles. With DRX extension, UEs are configured with longer Connected mode DRX cycle.

Despite the benefit of power saving, one major drawback of DRX extension is the handover performance degradation. The performance of the current network-controlled handover procedure, which is based on signaling in both source cell and target cell, is dependent on triggering the handover procedure at the best moment in time, which in turn depends on factors such as UE speed, radio deployment, and DRX cycle. More specifically, when DRX is applied, radio resource management (RRM) measurement is performed only within DRX ON durations, and longer DRX cycle leads to sparser measurement. When the handover trigger may be too late, and the radio link quality degrades below minimum requirement for successful transmission before handover complete, it is likely to result in handover failure (HoF). Thus, a high connection failure rate (radio link failure (RLF) or handover failure (HoF)) would be a normal case in networks where many UEs apply extended DRX cycle.

Since the poor mobility performance when applying extended DRX cycle mainly results from reduced number of measurements, a solution is sought to dynamically adjust the measurement interval so as to trigger the measurement reports in time. Furthermore, for moving UEs, higher handover failure rate is also observed when longer DRX cycle is configured. To improve the mobility robustness, a smart measurement procedure is desired so that more frequent measurements are applied when needed. If the smart measurement procedure is properly designed, then the UE is able to detect upcoming connection problems and perform corresponding handover procedures in time.

### SUMMARY

A method of mobility management with smart measurement is proposed. The present invention addresses modifications on RRM measurements as well as mobility control procedures in order to improve mobility performance for UE configured with longer connected mode DRX cycle. Since the poor mobility performance when applying extended DRX cycle mainly results from reduced number of measurements, one solution is to dynamically adjust the measurement interval so as to trigger the measurement reporting in time.

In one embodiment, a user equipment (UE) receives an extended Discontinuous Reception (DRX) configuration in a wireless communication network. The UE determines whether a triggering condition is satisfied for performing UE measurements. The triggering condition is associated with a radio link failure or a handover probability. The UE performs radio resource management (RRM) measurements with a first measurement interval (e.g., equal to the extended DRX cycle) if the triggering condition is not satisfied. The UE adjusts to a second measurement interval (e.g., equal to when no DRX configuration is applied) if the triggering condition is satisfied.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates mobility management with smart measurement of a user equipment (UE) applying discontinuous reception (DRX) configuration in an LTE network in accordance with one novel aspect.

FIG. 2 is a simplified block diagram of a UE for mobility management with smart measurement in accordance with one novel aspect.

FIG. 3 illustrates a message flow between a UE and a network for mobility management with smart measurement in accordance with one novel aspect.

FIG. 4 illustrates a first embodiment of early measurement corresponding to the event used for handover triggering.

FIG. 5 illustrates a second embodiment of smart measurement with multiple thresholds.

FIG. 6 is a flow chart of a method mobility management with smart measurement in a LTE network in accordance with one novel aspect.

### DETAILED DESCRIPTION

Reference will now be made in detail to some embodiments of the invention, examples of which are illustrated in the accompanying drawings.

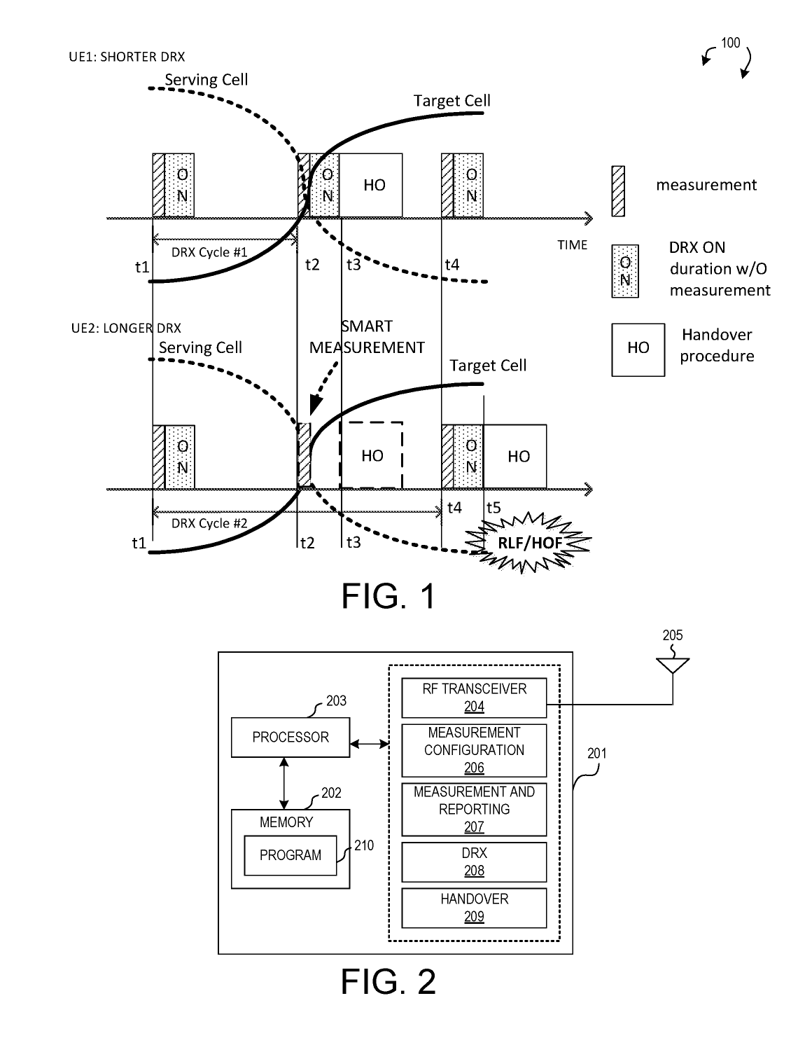

FIG. 1 illustrates mobility management with smart measurement of a user equipment (UE) applying discontinuous reception (DRX) configuration in an LTE/LTE-A network 100 in accordance with one novel aspect. In LTE/LTE-A systems, an evolved universal terrestrial radio access network (E-UTRAN) includes a plurality of evolved Node-Bs (eNBs) communicating with a plurality of mobile stations, referred as user equipments (UEs). Typically, each UE needs to periodically measure the received signal quality of the serving cell and neighbor cells and reports the measurement result to its serving eNB for potential handover or cell reselection. The measurements may drain the UE battery power. In order to keep UE battery consumption low, UE needs to toggle between sleeping and awake states. Preferably it should be possible for UEs in connected mode to apply similar sleep/awake performance as in Idle mode, to have similar battery consumption as in Idle mode. To save power, Discontinuous Reception (DRX) needs to be used in Connected mode, with short awake times and long sleep cycles. With DRX extension, UEs are configured with longer Connected mode DRX cycle.

In the example of FIG. 1, UE1 is configured with a normal DRX cycle #1 (up to 2.56 seconds). Each DRX cycle comprises a DRX ON period and a DRX OFF period. Without

DRX configuration, UE1 is typically configured with a default measurement interval for performing radio resource management (RRM) measurements. When DRX is applied, UE1 performs RRM measurements only within the DRX ON durations. At time t1, UE1 performs measurements once. Because the serving cell is very strong, no measurement event is triggered for measurement reporting. At time t2, UE1 again performs measurements once. Because the serving cell is becoming weaker and the target cell is becoming stronger, a certain measurement event is triggered for measurement reporting. As a result, UE1 performs handover from serving cell to target cell at time t3.

On the other hand, UE2 is configured with a longer DRX cycle #2 with DRX extension (up to four times of normal DRX cycle 4*2.56 s=10.24 s). For example, DRX cycle #2 is twice the length of DRX cycle #1. When DRX is applied, UE2 performs RRM measurements only within the DRX ON durations. At time t1, UE2 performs measurements once. Because the serving cell is very strong, no measurement event is triggered for measurement reporting. At time t2, UE2 does not perform any measurements during the DRX OFF period. At time t4 of the next DRX ON, UE2 again performs measurements once. Because the serving cell is much worse than the target cell, a certain measurement event is triggered for measurement reporting. As a result, the network commands UE1 for handover to target cell at time t5. However, the longer DRX cycle of UE2 leads to sparse measurements. As a result, the handover trigger at time t5 is too late, and the radio link quality of the serving cell degrades below minimum requirement for successful transmission before handover completes, resulting in radio link failure (RLF) or handover failure (HoF).

In accordance with one novel aspect, a method of mobility management with smart measurement is proposed. The present invention addresses modifications on RRM measurements as well as mobility control procedures in order to improve mobility performance for UE configured with longer connected mode DRX cycle. The method addresses the following problems: 1) under what conditions should smart measurements be triggered? 2) how should smart measurement be performed? And 3) additional UE assistance information for smart measurement configuration. As illustrated in FIG. 1, UE2 is configured with extended DRX and encounters poor mobility. Since the poor mobility performance when applying extended DRX cycle mainly results from reduced number of measurements, one solution is to dynamically adjust the measurement interval so as to trigger the measurement reporting in time. For example, additional measurements are performed at time t2 when a triggering criteria is met, indicating the change of handover triggering is high, or the UE is more vulnerable to handover failure. As a result, handover can be timely triggered at time t3 before RLF/HOF occurs to improve mobility performance.

FIG. 2 is a simplified block diagram of a UE 201 for mobility management with smart measurement in accordance with one novel aspect. UE 201 has memory 202, a processor 203, and radio frequency (RF) transceiver module 206. RF transceiver 204 is coupled with antenna 205, receives RF signals from antenna 207, converts them to baseband signals, and sends them to processor 203. RF transceiver 204 also converts received baseband signals from the processor 203, converts them to RF signals, and sends out to antenna 205. Processor 203 processes the received baseband signals and invokes different functional modules to perform features in UE 201. Memory 202 stores data and program instructions 210 to be executed by the processor to control the operations of UE 201. Suitable processors include, by way of example, a special purpose processor, a digital signal processor (DSP), a plurality of microprocessors, one or more microprocessors associated with a DSP core, a controller, a microcontroller, Application specific integrated circuits (ASICs), Field programmable gate array (FPGAs) circuits, and other type of integrated circuit (IC), and/or state machine. A processor in associated with software may be used to implement and configure features of UE 201.

UE 201 also includes multiple function modules and circuits that carry out different tasks in accordance with embodiments of the current invention. The function modules and circuits may be implemented and configured by hardware, firmware, software, and combinations of the above. Measurement configuration module 206 receives measurement and reporting configuration from the network, and configures its measurement interval and reporting criteria accordingly. Measurement and reporting module 207 performs various L1/L2 RRM measurements and L3 filtering for reference signal received power and/or reference signal received quality (RSRP/RSRQ) over serving and neighboring cells, and then determines whether any measurement event is triggered for measurement reporting. If so, then UE 201 starts a time-to-trigger (TTT) timer and reports measurement results to the network upon TTT timer expiry. Discontinuous Reception (DRX) module 208 configures UE 201 for DRX operation with corresponding DRX parameters received from the network. Each DRX cycle comprises alternating DRX ON duration and DRX OFF duration. Relevant DRX parameters include drx-Inactivity-Timer, shortDRX-Cycle, drxShortCycleTimer, longDRX-CycleStartOffset, onDurationTimer, HARQ RTT Timer, drx-RetransmissionTimer. For extended DRX configuration, UE 201 may be configured with much longer DRX cycle to further reduce power consumption. If DRX is configured, the measurement interval is the same as the DRX cycle, i.e., measurements are performed once within each DRX ON duration. Handover module 209 receives handover command from the network and performs handover procedure to handover UE 201 from a serving cell to a target cell.

In LTE systems, RRC connection reconfiguration message is used to configure UE measurement reporting. For example, LTE measurement events A1, A2, A3, A4, and A5 are based upon either RSRP or RSRQ measurements of the serving cell as compared to neighboring cells. The LTE event A1 is triggered when the serving cell becomes better than a threshold. The LTE event A2 is triggered when the serving cell becomes worse than a threshold. The LTE event A3 is triggered when a neighboring cell becomes better than the serving cell by an offset. The LTE event A4 is triggered when a neighboring cell becomes better than a threshold. The LTE event A5 is triggered when the serving cell becomes worse than a first threshold while a neighboring cell becomes better than a second threshold. Since the poor mobility performance when applying extended DRX cycle mainly results from reduced number of measurements, one solution of smart measurement is to dynamically adjust the measurement interval so as to trigger the measurement reporting in time. When smart measurement is configured, additional measurements are performed when the chance of handover triggering is high, or the UE is more vulnerable to handover failure.

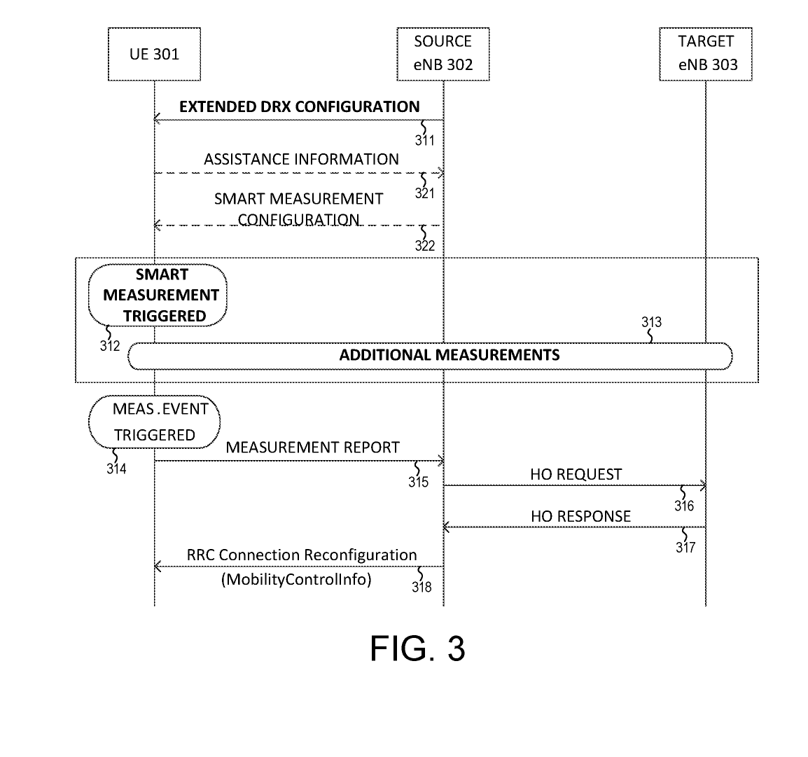

FIG. 3 illustrates a message flow between a UE and a network for mobility management with smart measurement in accordance with one novel aspect. In step 311, a user equipment UE 301 receives extended DRX configuration from its serving base station eNB 302. The extended DRX configuration configures UE 301 for long DRX cycle (e.g., up to 10.24 seconds). When DRX is configured, under normal situation, UE 301 performs RRM measurements once only during each DRX ON period to save power consumption. In step 312, UE 301 determines whether smart measurement is triggered based on a list of triggering criteria. If one of the triggering criteria is met, then in step 313, UE 301 performs additional measurements (e.g., during DRX OFF period) over the serving cell and neighboring cells (e.g., a target cell served by target base station eNB 303). In step 314, UE 301 determines whether a measurement reporting event is triggered. If one of the measurement reporting events (e.g., measurement reporting events A1 to A5) is triggered, then in step 315, UE 301 sends a measurement report to the serving eNB 302. Based on the measurement report, source eNB 302 initiates a handover procedure with target eNB 303. In step 316, eNB 302 sends a handover request to eNB 303. In step 317, eNB 303 sends a handover response back to eNB 302. In step 318, UE 301 receives an RRC connection reconfiguration message (including mobility control information) from source eNB 302 and handovers to target eNB 303.

Typical measurement requirements assume that a UE performs measurement once per DRX cycle (during DRX ON duration). With smart measurement, additional measurements and measurement report can be triggered, and the goal is to have quality measurement report in time and to trigger successful handover when longer DRX cycle is configured. In one advantageous aspect, the network does not need to reconfigure the UE for shorter DRX cycle, while still able to receive quality measurement report in time when the change of handover is high or when UE is more vulnerable to RLF or HOF. Note that with additional measurements, the UE may consume more power, however, the smart measurement is only triggered if necessary, e.g., when additional condition is satisfied. Overall, the smart measurement approach under DRX extension with longer DRX cycle improves mobility performance with more flexibility and power saving as compared to normal measurement under DRX configuration with shorter DRX cycle.

The smart measurement triggering criteria for additional measurements may include one or a subset of the following conditions. First, lower radio signal strength from the serving cell. In this case, UE needs more frequent measurements to find proper target for handover. New thresholds are defined to indicate the lower signal strength. The thresholds can be an absolute value (i.e. signal strength below some value) or relative value (i.e., comparing serving and neighbor cells). Second, when current evaluation timers (e.g., time-to-trigger (TTT), Treselection) are running. To have good quality measurement to trigger handover or avoid ping-pong, additional measurements are beneficial for UE to evaluate if the triggering criteria are still valid before the timers expire. Third, during user plane activity. Handover failure can be recovered by RRC re-establishment, under the cost of transmission interruption. With active data transmission, however, UE is more sensitive to interruption. Therefore, additional measurement is triggered during UP activity. Notice that for UE requiring measurement gap (e.g. inter-frequency measurements), additional measurements may impact data throughput, but the impact should be less than that due to connection reestablishment if smart measurement is properly configured. Also, autonomous gap behavior may be considered by such UEs to perform additional measurements. Fourth, when UE is in background state as compared to normal state. There is no need to have additional measurement (more power consumption) when the on-going traffic is only background traffic, because the user is not aware of the interruption. Furthermore, it is possible to extend measurement cycle (or reduce measurement frequency) if only background traffic is on-going.

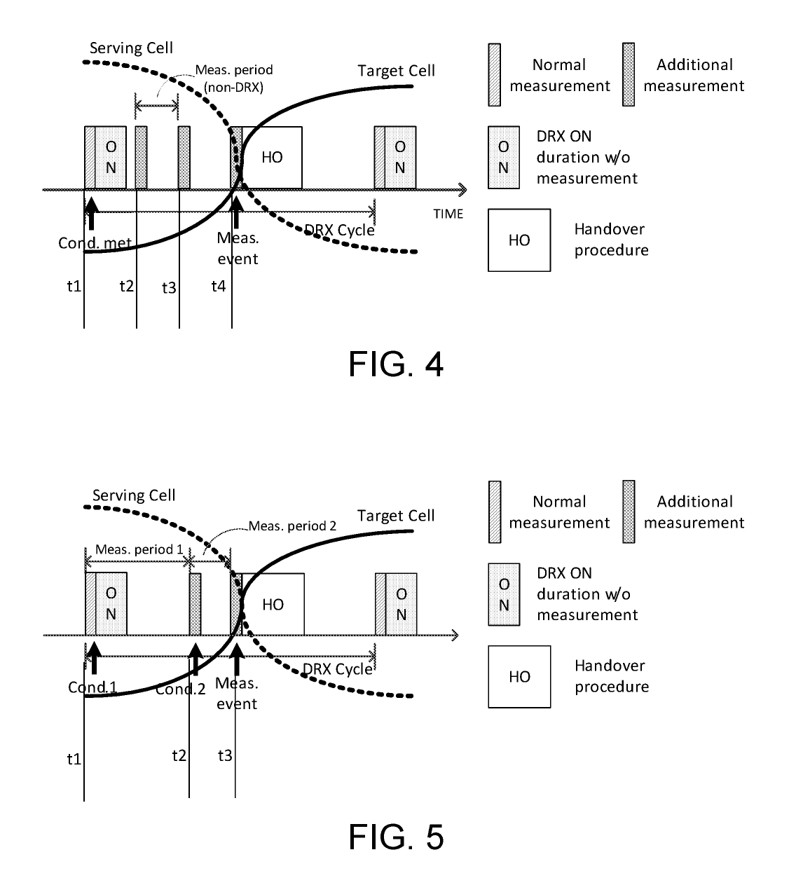

FIG. 4 illustrates a first embodiment of early measurement corresponding to the event used for handover triggering. In this embodiment, an early measurement event is introduced, corresponding to the event used for legacy handover triggering. For example, an event A3e similar to event A3 is defined as that a neighbor cell RSRP is offset-better than the serving cell RSRP, where the offset for A3e event is smaller than that for original A3 event. If the offset for A3 event is 3 dB, then the offset for A3e event may be 2 dB. Suppose that the normal measurement cycle is 1280 ms (e.g., same as the DRX cycle length). When the condition for such an early event is met at time t1, instead of starting the time-to-trigger (TTT) timer of A3 event, the UE reduces the measurement interval to that of non-DRX mode (e.g., 40 ms), and performs additional measurements at time t2, t3, t4, etc. In one example, at time t4, the UE detects that a measurement reporting event is triggered and sends out a measurement report to the network in time, which handovers the UE to a target cell to avoid potential RLF/HoF.

In measurements after event A3e triggered, it is possible that the condition for A3e is no longer satisfied. This may result from improved attenuation toward source eNB, or simply due to time-varying fading nature of wireless channels. To determine whether to keep more frequent measurements, a parameter N_{A3e} is introduced, and the UE switches back to normal measurement cycle if the condition for event A3e is not satisfied in N_{A3e} consecutive measurements. Notice that if the condition for event A3 is satisfied in any measurement, then the TTT timer is started and the UE behavior follows conventional handover procedures.

FIG. 5 illustrates a second embodiment of smart measurement with multiple thresholds. In this embodiment, the lengths of measurement intervals are variable, and are adjusted based on the measured signal strength. Multiple thresholds are introduced to the RRM measurement, corresponding to different measurement intervals. Assuming that the DRX cycle and the non-DRX mode measurement intervals are 1280 ms and 40 ms, respectively, an exemplary operation is described as follows. Five thresholds are configured, corresponding to five conditions. Using the A3/A3e event as an example, the first condition is offset=1 dB, the second condition is offset=1.5 dB, the third condition is offset=2 dB, the fourth condition is offset=2.5 dB, and the fifth condition is offset=3 dB. The UE starts with the measurement interval of 1280 ms under DRX mode, and the fulfillment of each condition halves the measurement interval. With above settings, the measurement interval becomes 640 ms when the first condition is met, and it is further shortened to 40 ms when the 5^{th} condition is met. In one example, at time t1, the first condition is met, and the measurement period 1=640 ms. At time t2, the second condition is met, and the measurement period 2=320 ms. At time t3, the UE detects that a measurement reporting event is triggered and sends out a measurement report to the network in time, which handovers the UE to a target cell to avoid potential RLF/HoF.

Though such a dynamic adjustment is more complicated than the previous one of FIG. 4, it provides better flexibility. As the UE gradually shortens the measurement intervals (instead of applying the shortest measurement interval of 40 ms at the beginning), the first threshold can be set looser than the threshold for additional measurements with fixed interval, without increasing the power consumption on measurements. In other words, the UE can start alert earlier.

Similar to the first embodiment, consider the case when later measurement results do not satisfy the conditions for additional measurements. When this happens, a measurement interval is chosen so that its corresponding threshold can be met by current measurement results. If none of the thresholds are met, the measurement interval is doubled. Eventually, the measurement interval is adjusted back to the original longer value of 1280 ms if none of the smart measurement thresholds are met in N_{A3e} consecutive measurements.

The above discussions focus on more frequent measurements for mobility performance. In fact, the proposed smart measurement also includes reduced measurements for power saving purpose. Measurement interval longer than DRX cycle can be configured when the link to serving cell is constantly in good condition (e.g. for stationary UEs). Note that measurement event A3 is used as one example, other measurement events and criteria can also be used for adjusting the measurement intervals under smart measurement.

While the UE itself can configure for smart measurement parameters, the eNB may request UE to feedback assistance information and then configure smart measurement parameters for the UE. Referring back to FIG. 3, in step 321, UE 301 sends assistance information to eNB 302. In step 322, eNB 302 provides smart measurement configuration parameters to UE 301 (e.g., triggering criteria and conditions, measurement intervals). The assistance information may include one or a subset of the following parameters. 1) Power-saving preference indication: For a UE indicating its preference of lower power consumption, the eNB may configure a higher threshold or longer interval for smart measurements. 2) Mobility: For high-mobility UEs, faster triggering and shorter measurement intervals are preferred. In contrast, higher triggering thresholds and relatively long measurement intervals are configured for UEs with lower mobility. For almost stationary UEs, the eNB may even configure smart measurements with intervals longer than DRX cycle. 3) Traffic type: An important concern of handover failure is the increased interruption time results from attendant connection reestablishment. For traffic with lower delay tolerance, more aggressive dynamic measurement should be configured to avoid handover failure. In contrast, background traffics usually have higher delay tolerance, and thus longer measurement intervals can be applied. 4) Other information: including current measurement cycle, handover success/failure history, and so on. Note that when measurement is performed outside active time, since it is not possible for eNB to schedule the UE, the UE is not required to perform data reception (i.e., reading PDCCH).

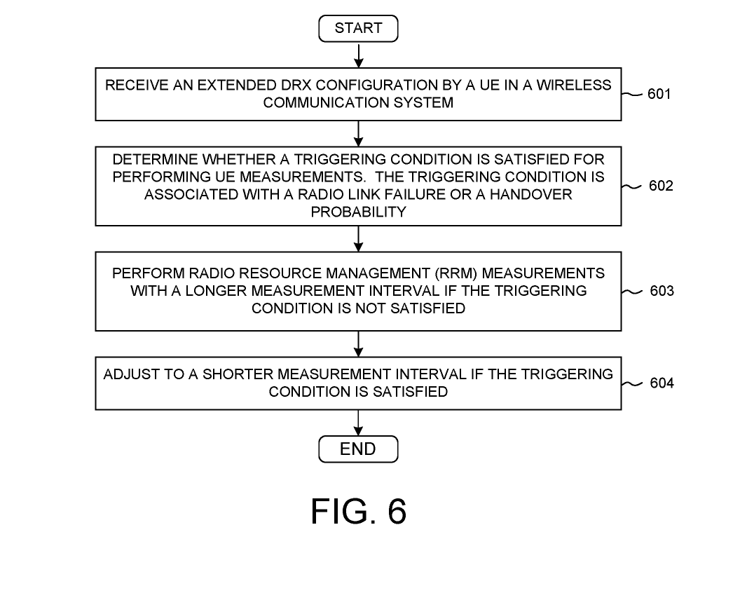

FIG. 6 is a flow chart of a method mobility management with smart measurement in a LTE network in accordance with one novel aspect. In step 601, a user equipment (UE) receives an extended Discontinuous Reception (DRX) configuration in a wireless communication network. In step 602, the UE determines whether a triggering condition is satisfied for performing UE measurements. The triggering condition is associated with a radio link failure or a handover probability. In step 603, the UE performs RRM measurements with a first longer measurement interval (e.g., equal to the extended DRX cycle) if the triggering condition is not satisfied. In step 604, the UE adjusts to a second shorter measurement interval (e.g., equal to when no DRX configuration is applied) if the triggering condition is satisfied.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving an extended Discontinuous Reception (DRX) configuration by a user equipment (UE) in a wireless communication system;
determining whether a triggering condition is satisfied for performing UE measurements, wherein the triggering condition is associated with a radio link failure or a handover probability;
performing radon resource management (RRM) measurements with a first measurement interval if the triggering condition is not satisfied; and
adjusting to a second measurement interval if the triggering condition is satisfied.

2. The method of claim 1, wherein the UE performs measurements only during a DRX ON period if the triggering condition is not satisfied.

3. The method of claim 2, wherein the UE performs additional measurements during a DRX OFF period if the triggering condition is satisfied.

4. The method of claim 1, wherein the triggering condition is satisfied if a radio signal strength from a serving cell is lower than a first threshold or if a radio signal strength from a target cell is higher than a second threshold.

5. The method of claim 4, wherein the UE adjusts the measurement interval based on a previous measurement result of the radio signal strength.

6. The method of claim 4, wherein multiple measurement intervals are applied corresponding to multiple radio signal strength threshold.

7. The method of claim 1, wherein the UE continue to apply the shorter measurement interval when a current evaluation timer is running and if the triggering condition is still satisfied.

8. The method of claim 1, further comprising:
determining whether the UE is in a normal state or a background state, wherein the triggering condition is not satisfied if the UE is in the background state.

9. The method of claim 1, further comprising:
transmitting UE assistance information to a serving base station; and
receiving information from the serving base station for determining the triggering condition and the adjusted measurement interval in response to the UE assistance information.

10. The method of claim 9, wherein the UE assistance information comprises at least one of a UE power-saving preference, UE mobility information, and a UE traffic type.

11. A user equipment (UE), comprising:
a radio frequency (RF) receiver that receives an extended Discontinuous Reception (DRX) configuration by a user equipment (UE) in a wireless communication system;
a measurement configuration circuit that determines whether a triggering condition is satisfied for performing UE measurements, wherein the triggering condition is associated with a radio link failure or a handover probability; and
a measurement circuit that performs radon resource management (RRM) measurements with a first measurement interval if the triggering condition is not satisfied, wherein the UE adjusts to a second measurement interval if the triggering condition is satisfied.

12. The UE of claim 11, wherein the UE performs measurements only during a DRX ON period if the triggering condition is not satisfied.

13. The UE of claim 12, wherein the UE performs measurements during a DRX OFF period if the triggering condition is satisfied.

14. The UE of claim 11, wherein the triggering condition is satisfied if a radio signal strength from a serving cell is lower than a first threshold or if a radio signal strength from a target cell is higher than a second threshold.

15. The UE of claim 14, wherein the UE adjusts the measurement interval based on a previous measurement result of the radio signal strength.

16. The UE of claim 14, wherein multiple measurement intervals are applied corresponding to multiple radio signal strength threshold.

17. The UE of claim 11, wherein the UE continue to apply the shorter measurement interval when a current evaluation timer is running if the triggering condition is still satisfied.

18. The UE of claim 11, further comprising:
determining whether the UE is in a normal state or a background state, wherein the triggering condition is not satisfied if the UE is in the background state.

19. The UE of claim 11, further comprising:
a transmitter that transmits UE assistance information to a serving base station, wherein the UE receives information from the serving base station for determining the triggering condition and the adjusted measurement interval in response to the UE assistance information.

20. The UE of claim 19, wherein the UE assistance information comprises at least one of a UE power-saving preference, UE mobility information, and a UE traffic type.
